(19) United States
(12) Patent Application Publication
(10) Pub. No.: US 2026/0088964 A1
(43) Pub. Date: Mar. 26, 2026

(54) CONDITIONAL CONFIGURATION AND ACTIVATION OF SECONDARY CELLS

(71) Applicant: Apple Inc., Cupertino, CA (US)

(72) Inventors: Jie Cui, San Jose, CA (US); Haitong Sun, Saratoga, CA (US); Konstantinos Sarrigeorgidis, Los Gatos, CA (US); Manasa Raghavan, Sunnyvale, CA (US); Qiming Li, Beijing (CN); Xiang Chen, Campbell, CA (US); Yang Tang, San Jose, CA (US); Yuexia Song, Beijing (CN)

(73) Assignee: Apple Inc., Cupertino, CA (US)

(21) Appl. No.: 19/310,590

(22) Filed: Aug. 26, 2025

Related U.S. Application Data
(60) Provisional application No. 63/699,583, filed on Sep. 26, 2024.

(51) Int. Cl. H04L 5/00

(52) U.S. Cl. CPC H04L 5/0098; H04L 5/001

(57) ABSTRACT

The present application relates to devices and components including apparatus, systems, and methods for configuration and/or activation operations for secondary cells.

### CROSS-REFERENCES TO RELATED APPLICATIONS

This application claims the benefit to U.S. Provisional Application No. 63/699,583, filed Sep. 26, 2024, entitled “Conditional Configuration And Activation Of Secondary Cells,” the disclosure of which is incorporated by reference in its entirety and for all purposes.

### TECHNICAL FIELD

The present application relates to the field of wireless technologies and, in particular, to configuration and activation of secondary cells.

### BACKGROUND

Third Generation Partnership Project (3GPP) networks provide for carrier aggregation, where a user equipment (UE) can be served by one or more cells. In particular, a primary cell and one or more secondary cells can provide service to the UE. The primary cell and the secondary cells need to be configured and/or activated for serving the UE.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates an example network arrangement in accordance with some embodiments.

FIG. 5 illustrates an example secondary cell (SCell) addition and activation procedure in accordance with some embodiments.

FIG. 6 illustrates an example SCell addition and activation procedure in accordance with some embodiments.

FIG. 7 illustrates an example procedure for configuring SCells in accordance with some embodiments.

FIG. 8 illustrates an example procedure for activating SCells in accordance with some embodiments.

FIG. 9 illustrates an example procedure for conditional addition and/or activation of SCells in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Approaches described throughout this disclosure can provide conditional configuration and/or activation of secondary cells (SCells) for user equipments (UEs). Legacy approaches for configuration and the activation of SCells tended to be relatively complicated and tended to be relatively time consuming. In particular, a network (NW) and UE would require exchanging multiple messages for the NW to configure and activate SCells for the UE.

The approaches described herein can allow a UE to conditionally add SCells to configured SCells and/or to conditionally activate SCells. Allowing the UE to perform these operations rather than requiring the NW to configure and activate SCells for the UE can reduce the amount of signaling required between the NW and the UE for configuring and activating the SCells. Additionally, the approaches described herein can reduce the time for configuration and activation of SCells for a UE as compared to legacy approaches.

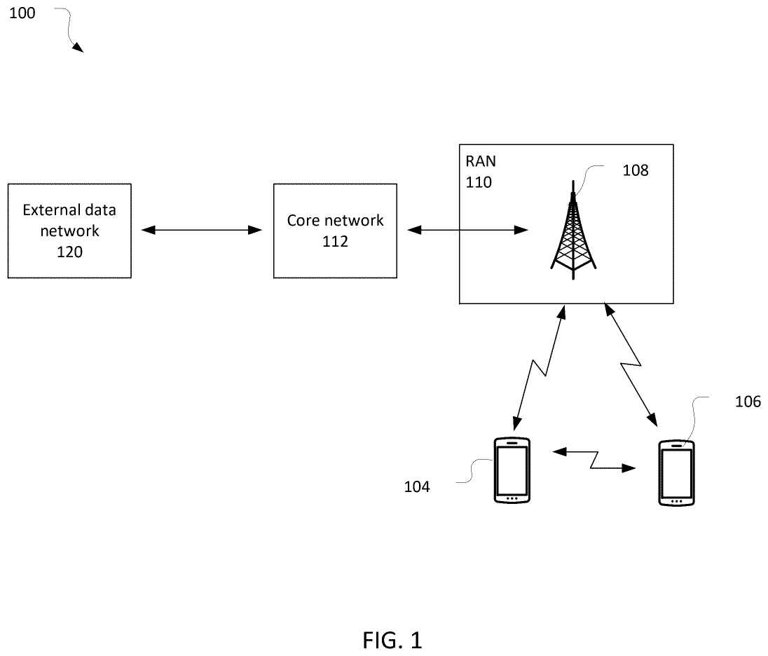

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

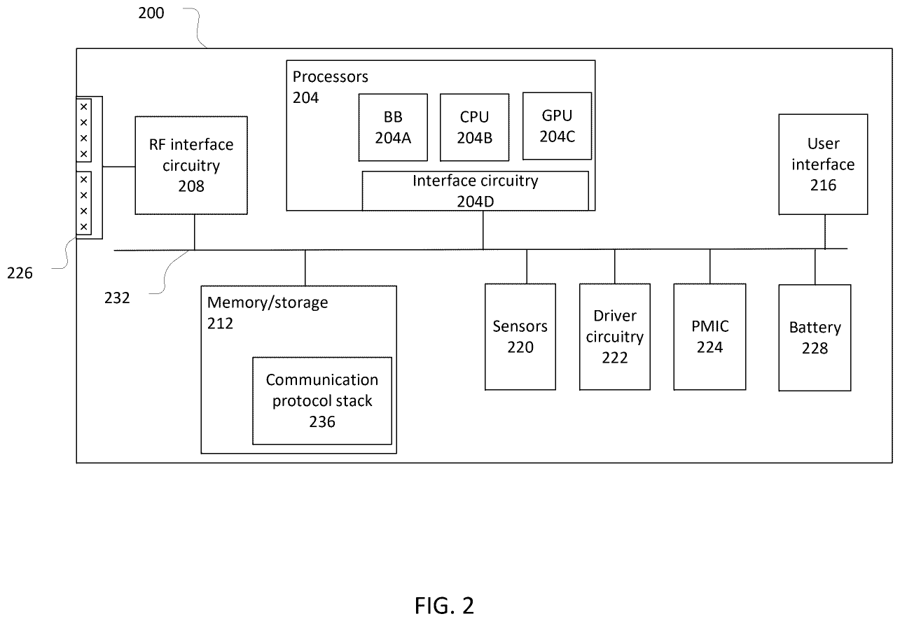

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. In some embodiments, processor 204 may include RF interface circuitry 208. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

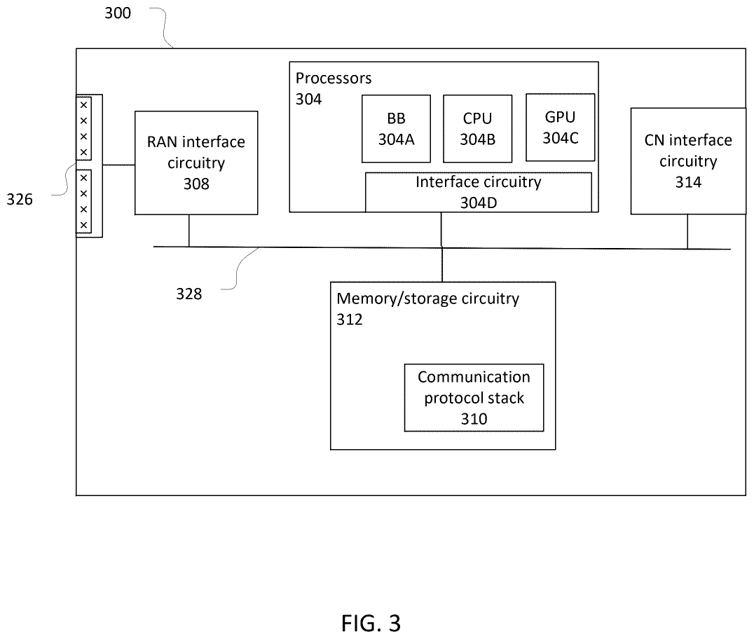

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

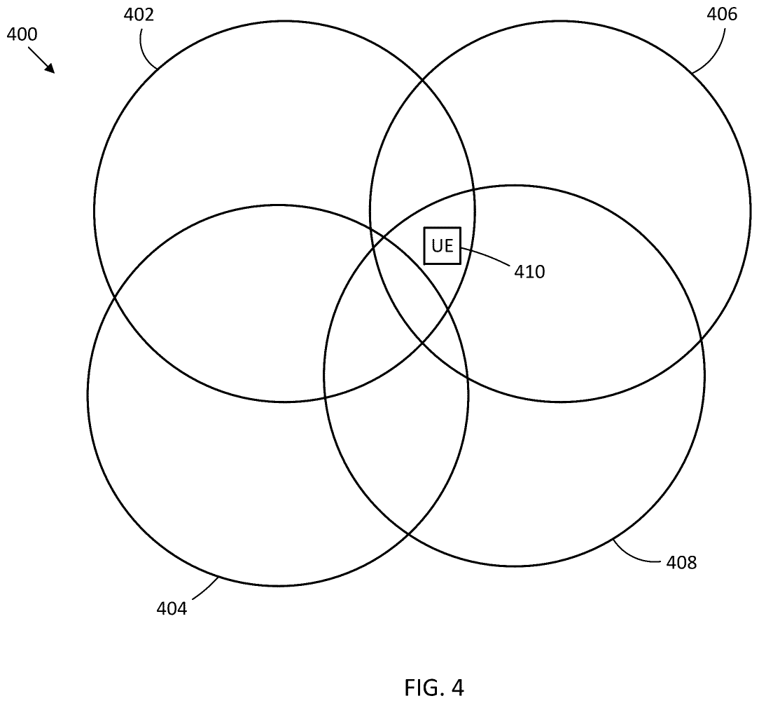

FIG. 4 illustrates an example network arrangement 400 in accordance with some embodiments. In particular, the 400 illustrates multiple cells that may be hosted by a network. Each of the cells may be hosted by a base station (such as the base station 108 (FIG. 1) and/or the network device 300 (FIG. 3)), where one base station may host a single cell or multiple cells. A cell can be configured to provide services to one or more UEs located within the cell. For example, the base station hosting the cell may communicate with one or more of the UEs located within the cell to allow the network to provide services to the one or more of the UEs.

The arrangement 400 may include one or more cells. In the illustrated example, the arrangement 400 includes a first cell 402, a second cell 404, a third cell 406, and a fourth cell 408. The first cell 402, the second cell 404, the third cell 406, and the fourth cell 408 may be hosted by a same base station, may be hosted by different base stations, or some combination thereof. Each of the cells may provide services to one or more UEs located within the cells. For example, one or more of the UEs may establish connections with one or more of the corresponding cells, where the cells can provide access the connected UEs access to the network.

The arrangement 400 includes a UE 410. The UE 410 may include one or more of the features of the UE 104 (FIG. 1), the UE 106 (FIG. 1), and/or the UE 200 (FIG. 2). The UE 410 is located within the first cell 402, the third cell 406, and the fourth cell 408 in the illustrated embodiment. The UE 410 may establish connections with one or more of the first cell 402, the third cell 406, and the fourth cell 408. The UE 410 may perform an initial connection establishment procedure or a connection re-establishment procedure with one of the cells, which may be referred to as a primary cell (PCell). In some instances, the UE 410 may be configured for dual connectivity operation and the UE may perform random access with another of the cells when performing reconfiguration with synchronization process, where the other cell may be referred to as a primary secondary cell group cell (PSCell). When the UE 410 is configured with carrier aggregation, one or more of the other cells may provide additional resources to the UE 410, where the one or more other cells may be referred to as a secondary cell (SCell). As an example, the first cell 402 may operate as a PCell for the UE 410, and the third cell 406 and/or the fourth cell 408 may operate as SCells for the UE 410 in some instances.

Procedures described throughout this disclosure may be utilized for configuring and/or activating SCells for a UE. For example, a UE may have established a connection with a PCell and/or a PSCell. While connected with the PCell and/or the PSCell, the UE may operate with the PCell and/or the PSCell to configure and/or activate SCells for providing additional resources to the UE, as described throughout this disclosure.

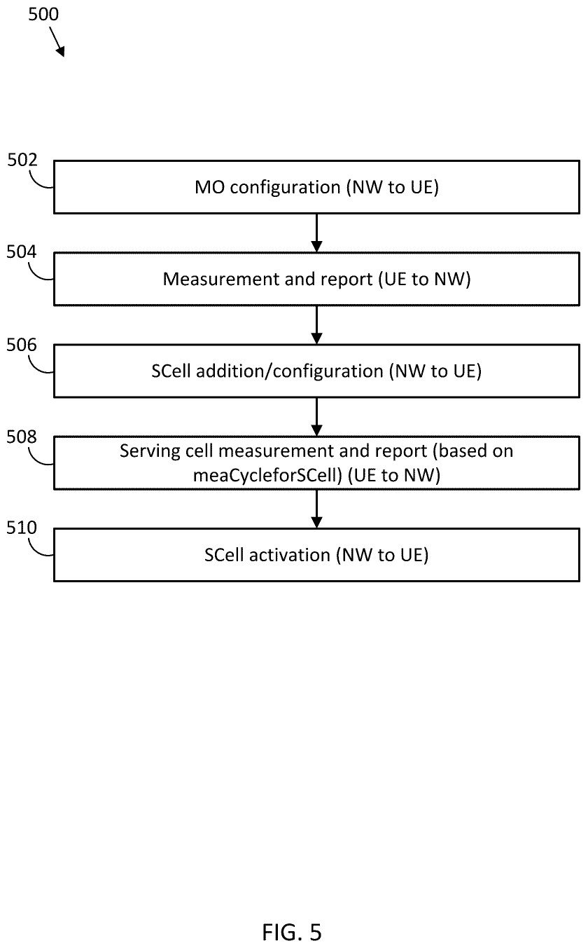

In fifth generation (5G), the CA operation is on the secondary cell (SCell) or SCells, and to make use of such SCell for UE, it needs a complicated procedure for SCell addition and activation. FIG. 5 illustrates an example SCell addition and activation procedure 500 in accordance with some embodiments. For example, the procedure 500 is an example of a legacy procedure that can be implemented for adding and activating SCells.

As shown in the procedure 500, a network (NW) configures measurement object(s) of component carrier(s) (CC(s)) to a UE for measurement report in 502. For example, the NW transmits measurement object (MO) configuration information of CCs to a UE. The MO configuration information allows the UE to perform measurements of the CCs and generate one or more measurement reports for the CCs. 502 may be optional.

In 504, the UE will measure the neighbor cells on target CC(s) and report the measurement results back to the NW. For example, the UE measures the neighbor cells on the target CCs and generates a measurement report for transmission to the NW in accordance with the MO configuration information from 502. 504 may be optional, according to 502/

Based on the UE measurement reports, the NW can choose some cell(s) to be an SCell for this UE and use a radio resource control (RRC) information element (IE) to add/configure this target cell as an SCell to the UE, or the NW can also do such addition/configuration without any UE reports (blind SCell addition) in 506. During SCell configuration, the NW may also configure the measurement on this SCell to the UE. After SCell configuration, this SCell is a configured deactivated SCell in legacy CA operation. Release 16 (R16) direct SCell activation was not considered in 5G.

The UE will perform serving cell measurement of the configured deactivated SCell and then report the measurement results back to the NW in 508. For example, the UE will perform a serving cell measurement of the configured deactivated SCell configured in 506. The UE will generate a report including the measurement results and transmit the report to the NW.

Based on the UE measurement reports, the NW can decide to activate the SCell for this UE for capacity enhancement via activation command on medium access control (MAC) control element (CE), or the NW can also do such activation without any UE reports (blind SCell activation) in 510.

The procedures are very complicated and it will have high time consumption to complete SCell activation at the UE, i.e., from a neighbor cell to be an activated SCell to UE. Also in the 5G specification, the delay requirement for SCell activation is defined as following. The following is one example for unknown SCell activation.

Upon receiving SCell activation command in slot n, the UE shall be capable to transmit valid channel state information (CSI) report and apply actions related to the activation command for the SCell being activated no later than in slot

$$n + \frac{{T}_{HARQ} + {T}_{activation \_ time} + {T}_{CSI \_ Reporting}}{NR slot length} ,$$

where:
T_{HARQ} (in ms) is the timing between downlink (DL) data transmission and acknowledgement as specified in technical specification (TS) 38.213 [3].
T_{activation}_time is the SCell activation delay in millisecond.

If the SCell is unknown and belongs to frequency range 1 (FR1), provided that the side condition Ês/Iot is greater than or equal to −2 dB is fulfilled, then T_{activation_time} is:

$${T}_{FirstSSB \_ MAX} + {T}_{SMTC \_ MAX} + 2 * {T}_{rs} + 5 ms$$

If the target SCell is unknown to UE and semi-persistent channel state information-reference signal (CSI-RS) is used for CSI reporting, provided that the side condition Ês/Iot is greater than or equal to −2 dB is fulfilled, then T_{activation_time} is:

$$6 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + {T}_{HARQ} + max ( {T}_{uncertainty \_ MAC} + {T}_{FineTiming} + 2 ms , {T}_{uncertainty \_ SP} ) .$$

If the target SCell is unknown to UE and periodic CSI-RS is used for CSI reporting, provided that the side condition Ês/Iot is greater than or equal to −2 dB is fulfilled, then T_{activation_time} is:

$$3 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + max \{ ( {T}_{HARQ} + {T}_{uncertainty \_ MAC} + 5 ms + {T}_{FineTiming} ) , ( {T}_{uncertainty \_ RRC} + {T}_{RRC \_ delay} ) \} .$$

The activation delay is pretty long for SCell. For unknown SCell, it relies on the UE report but it needs NW to schedule the uplink grant (UL) grant for layer 3 (L3) reporting first before the SCell activation.

In order to limit the time delay of SCell addition/activation and simplify the procedure (UE does not need to report L3 before activation but can still speed up the activation), the conditional SCell activation and SCell addition can be considered. For example, in some embodiments conditional SCell addition and release may be based on preconfigured reference signal received power (RSRP)/reference signal received quality (RSRQ)/signal to interference plus noise ratio (SINR) threshold and max CC number. Further, conditional SCell activation and deactivation may be based on preconfigured RSRP/RSRQ/SINR threshold and data traffic status in some embodiments. In embodiments, a network and UE arrangement may implement both conditional addition and release of SCells, and conditional activation and deactivation of SCells based on preconfigured RSRP, RSRQ, and/or SINR thresholds. In other embodiments, a network and UE implementation may implement one or the other of conditional addition and release of SCells, and conditional activation and deactivation of SCells based on preconfigured RSRP, RSRQ, and/or SINR thresholds.

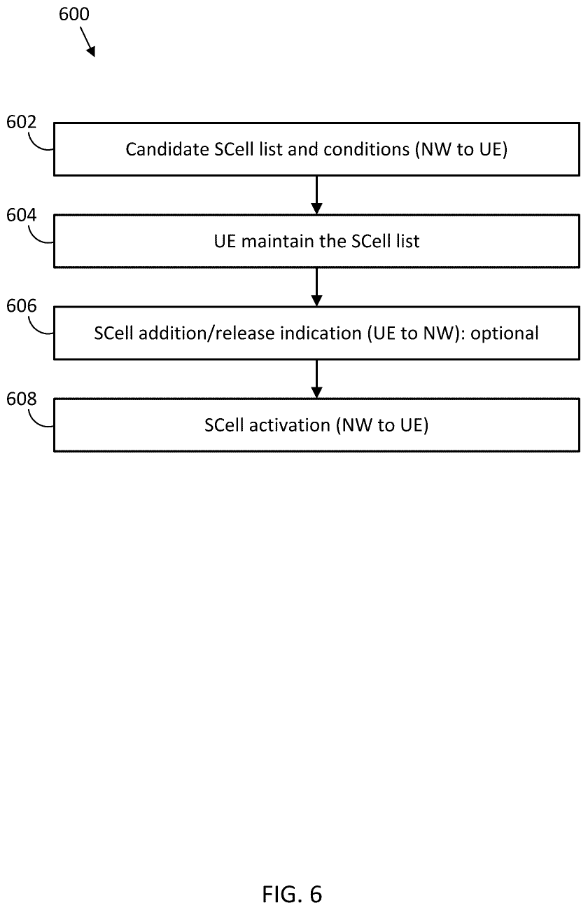

FIG. 6 illustrates an example SCell addition and activation procedure 600 in accordance with some embodiments. For example, the procedure may be performed by a network and UE arrangement that implements both SCell addition/release based on preconfigured RSRP, RSRQ, and/or SINR thresholds and SCell activation/deactivation based on preconfigured RSRP, RSRQ, and/or SINR thresholds.

For conditional SCell operation, conditional SCell addition and release may be based on preconfigured RSRP/RSRQ/SINR threshold and max CC number. The NW may provide a candidate CC list for CA as well as the RSRP/RSRQ/SINR threshold for qualified candidate SCells to the UE in 602. For example, the NW may generate a candidate CC list that indicates CCs that can be utilized as SCells by the UE. The CCs may correspond to cells in which the UE is located and/or which are located near a current position of the UE. The NW may determine a threshold value for determining qualified candidate SCells from the CCs in the candidate CC list. The threshold value may be an RSRP value, an RSRQ value, an SINR value, or a value generated from some combination of RSRP, RSRQ, and/or SINR. The NW may transmit an indication of the threshold value with the candidate CC list or may transmit a separate transmission that includes an indication of the threshold value. In some embodiments, the NW may omit the transmission of the threshold value, where the threshold value may be defined in another manner, such as being defined in a specification.

In the candidate CC list, the cell index and CC frequency are provided, and those CCs are the potential SCell candidates. For example, the CC list may include one or more cell indexes and one or more CC frequencies. The CCs indicated by the one or more cell indexes and the one or more CC frequencies may be potential SCell candidates for the UE.

In a first option, the UE may use these CCs in the candidate list as the configured/added SCells as the starting stage. For example, the UE may update a list of configured SCells for the UE with the CCs indicated in the candidate CC list provided by the NW.

In a second option, these CCs in the candidate list may not be added to the configured/added SCells until the UE identified some or all of them can meet the RSRP/RSRQ/SINR threshold. The UE can add those CCs which meet the threshold in the candidate list to be real added SCells. For example, the UE may identify the CCs indicated by the candidate SCell list. The UE may initially store the CCs as semi-configured/added SCells, where the CCs have yet to be added to the list of configured SCells. The UE may perform measurements of the CCs to determine whether the resultant values of the measurements of the CCs meet the threshold value related to RSRP, RSRQ, and/or SINR. The UE may determine which CCs have resultant values of the measurements that meet the threshold value and configure/add these CCs to the list of configured SCell, which can be referred to as real added SCells. The CCs that the UE determines do not have resultant values of the measurements that meet the threshold value may be maintained in the semi-configured/added SCells that can be remeasured at other times to determine if the threshold value is met at the other times. The CCs in the list of configured SCells may be available for activation, whereas the CCs maintained in the semi-configured/added SCells may not be available for activation.

In a third option, the NW can mark CCs in the candidate list as real configured/added SCell or semi-configured/added SCells. Real configured/added SCell means the NW decides that these SCells are the added SCells without UE decision. Semi-configured/added SCells means the CCs as described in second option. For example, the candidate SCell list provided by the NW in 602 may include indications of which CCs in the candidate SCell list are to be treated as real configured/added SCells and which CCs in the candidate SCell list are to be treated as semi-configured/added SCells. The UE may determine which CCs in the candidate SCell list are to be treated as real configured/added SCells and which CCs in the candidate SCell list are to be treated as semi-configured/added SCells based on the indications. For the CCs that the UE determines are to be treated as real configured/added SCells, the UE may add the CCs to the list of configured SCells. For the CCs that the UE determines are to be treated as semi-configured/added SCells, the UE may perform the measurements of the CCs and determine whether the CCs are to be added to list of configured SCells based on whether the resultant values of the measurements meet the threshold value, as described in relation to the second option described above.

The RSRP/RSRQ/SINR threshold can be configured as a single threshold among different candidate CCs, different thresholds among different candidate CCs, different thresholds among different candidate bands, but same threshold for CCs inside a band, or different thresholds among different frequency range, but same threshold for CCs inside a FR. For example, the threshold value for determining which CCs are to be included in the list of configured SCells may include a single threshold value for all the CCs within the candidate SCell list, different threshold values for different CCs within the candidate SCell list, different threshold values for different candidate bands for the CCs within the candidate SCell list, or different threshold values for different frequency ranges for the CCs within the candidate SCell list. When determining whether a measurement result for a CC meets the threshold value, the UE may utilize the corresponding threshold value.

The UE can decide to add and release SCells based on the condition set by the NW. For example, the UE can use the threshold to decide which SCell shall be added or removed/released in the configured SCell list. The UE may perform measurements of the CCs within the list of configured SCells and the semi-configured/added SCells at set intervals, when triggered, or some combination thereof. The UE may compare the resultant values of the measurements of the CCs with the corresponding threshold to determine which of the CCs are to be included in the list of configured SCells or in the semi-configured/added SCells. The UE may update the list of configured SCells and the semi-configured/added SCells by adding or removing/releasing any CCs that have been determined to have changed between the list of configured SCells and the semi-configured/added SCells based on the threshold comparisons.

The UE may maintain the SCell list in 604. For example, the UE may update the list of configured SCells in accordance with the approaches described above for determining which CCs are to be included in the list of configured SCells and to be included in the semi-configured/added SCells.

The UE may indicate to the NW which CCs are added and/or released from the list of configured SCells in 606. For example, the UE may generate an indication of the CCs included in the list of configured SCells and/or generate an indication of one or more SCells added or removed from the list of configured SCells. The UE may transmit the indication to the NW. In some embodiments, 606 may be omitted.

In a first alternative, the UE may indicate the SCell list change once it releases or adds SCells in the configured SCell list. For example, the UE may generate and transmit the indication of an SCell being added or removed from the list of configured SCells in response to the SCell being added or removed. Such indication can be on radio resource control (RRC), medium access control (MAC), or physical layer (PHY). The indication may include a list of cell indexes and/or carrier frequencies in some embodiments. The list may be equal to or a sub-list of the candidate SCell list configured by the NW in 602. In some embodiments, the indication may include a bitmap of candidate SCell list configured by the NW. For example, if initially the NW configures 8 candidate SCells to add (cell 1/2/3/4/5/6/7/8), and after the UE checks these candidates' RSRP/RSRQ/SINR value(s) with the threshold, the UE may indicate 00110000 in the bitmap that means cell 3/4 can be added because bit position is “1” for these two cells. And for SCell release, the UE may indicate 00010000 in the bitmap that means, cell 3 is not qualified for an SCell, and UE released this cell 3 but still kept cell 4 as a configured SCell in this case.

In a second alternative, the UE may indicate the current SCell list triggered by an NW request. For example, the NW may generate and transmit a request for a current list of configured SCells of the UE. In response to identifying the request, the UE may generate and transmit an indication of the CCs within a current list of configured SCells. Such indication can be on RRC, MAC, or PHY. The NW may request the UE to indicate the current SCell list according to different purposes. For a first purpose, the NW may identify the UE mobility change (e.g., handover (HO), PCell/PSCell change, RRC redirection), then NW may request the UE to indicate the current SCell list. For a second purpose, the NW may want to reconfigure the candidate list, then the NW may request the UE to indicate the current SCell list. For a third purpose, the NW may want to activate or use some SCell for capacity enhancement, then the NW may request the UE to indicate the current SCell list.

In a third alternative, the UE may indicate the current SCell list triggered by some events. For example, the UE may identify an occurrence of a defined event. The UE may generate and transmit an indication of the CCs within the current list of configured SCells. Such event may be configured by the NW or predefined in the specification. Such indication can be on RRC, MAC, or PHY. The UE may indicate the current SCell list according to different event, such as UE mobility change (e.g., HO, PCell/PSCell change, RRC redirection), radio link failure (RLF) on the PCell, beam failure on the PCell or the SCell, or RRC reestablishment.

In a fourth alternative, the NW can blind activate secondary component carriers (SCCs) for the UE without reporting of the SCell list. When the UE completes the activation, the UE may report the channel quality information (CQI) with physical cell identity (PCI) index to the NW. This PCI index can let the NW know this SCell is ready to be used for capacity enhancement. When the SCells are released based on UE decision, UE may not need to keep monitoring these SCells as deactivated SCell measurement.

The approaches described above in relation to 602, 604, and 606 may be for conditional SCell additional and release based on the threshold value and/or the maximum CC number. The approaches can present some advantages. The advantages may include the SCell addition and release may be more efficient than the legacy way, e.g., RRC reconfiguration is not needed every time. Further, all of the SCells in the candidate list may be known SCell for activation. The UE can selectively monitor the deactivated SCell, e.g., for those SCells not qualified for a deactivated SCell, the UE can release them and may not need to keep monitoring these SCell as deactivated SCell measurement.

UE may need to let the NW know the SCell list in some cases. The measurement gap (MG) or other measurement behavior might be changed, e.g., some SCell becomes non-serving cell and then MG might be needed.

In 608, SCell activation may occur. For example, the NW may generate and transmit a candidate activation CC list to the UE to be utilized for conditional SCell activation and/or deactivation. Conditional SCell activation and deactivation may be based on preconfigured RSRP/RSRQ/SINR threshold and data traffic status. The preconfigured RSRP/RSRQ/SINR threshold may be a same threshold used for determining whether CCs are to be included in the list of configured SCells or may be a different threshold.

For uplink (UL) traffic demand, the legacy approach includes the UE sending a scheduling request (SR) to the NW, the NW gave the UE a UL grant, the UE sends a buffer status report (BSR) to the NW, and the NW decides whether the SCell shall be activated for UE or not.

For a new approach for UL traffic demand, if the PCell is only used for coverage purpose but not for capacity enhancement, the conditional SCell activation may be used when UE has larger UL traffic demand.

For a first option, the NW may provide a candidate activation CC list for activation as well as the RSRP/RSRQ/SINR threshold for qualified candidate SCells. The candidate activation CC list may be a subset of or equal to the set of the list of real configured SCells. For example, the NW may determine one or more CCs that may be available for activation. The one or more CCs may be determined from a list of configured SCells maintained by the NW, where the candidate activation CC list may include all of the CCs within the list of configured SCells or a subset of the CCs within the list of configured SCells. The list of configured SCells maintained by the NW may include the CCs indicated in the candidate SCell list transmitted to the UE by the NW. In some embodiments, the NW providing the RSRP/RSRQ/SINR threshold may be omitted, such as when the threshold may be defined in a specification. The UE may activate the SCell once the condition is met after UL traffic arrives at the buffer for transmission, and the UE may indicate to network which SCells are activated. The UE may indicate the SCell activation and deactivation results to network once it completes one or more activation/deactivation of SCell(s). The RSRP/RSRQ/SINR threshold can be configured as a single threshold among different candidate CCs, different thresholds among different candidate CCs, different thresholds among different candidate bands, but the same threshold for CCs inside a band, or different thresholds among different frequency range, but same threshold for CCs inside a frequency range (FR).

There may be alternatives for the indication of activated SCells from the UE to the NW. For a first alternative, the indication may be provided via a PCell/PSCell or another activated SCell, e.g., valid CQI reporting or other new signaling indication. The valid CQI reporting may be associated with the cell index of the configured SCell, and after the NW receives valid CQI of this SCell, the NW can know this SCell has been activated by UE. In some instances of the first alternative, a list of cell index or carrier frequency may be provided by the UE as the indication. The list may be equal to or a sub-list of the candidate activation CC list. In some instances of the first alternative, the indication may include a bitmap of candidate activation list configured by the NW. For example, if initially the NW configures 8 candidate SCells to activate (cell 1/2/3/4/5/6/7/8), after the UE checks these candidates' RSRP/RSRQ/SINR measurement values with the threshold and after the UE completes the activation of cells 3/4, the UE may indicate 00110000 in the bitmap. That means cell 3/4 have been activated because bit position is “1” for these two cells. And for SCell deactivation, the UE may indicate 00010000, that means SCell 3 has been deactivated. The UE may release this SCell 3 but still keep cell 4 as an activated SCell in this case.

In a second alternative, the indication may include a random access channel (RACH) on the activated SCell. For example, the UE may generate a RACH transmission and transmit the RACH transmission on an activated SCell to indicate that the SCell has been activated. After the UE completes one SCell activation, the UE may send RACH on that SCell.

For the first alternative and/or the second alternative, the UE may send a scheduling request (SR) together with such above indication, and the NW can schedule UL grant for UL traffic on different CCs immediately.

For a second option of SCell activation, a candidate activation CC list for activation can be the list of real added SCell at the UE, and the NW may provide a RSRP/RSRQ/SINR threshold for qualified candidate SCells. For example, the candidate activation CC list transmitted by the NW to the UE may include the CCs indicated by the UE to the NW as being configured and/or included in the list of configured SCells stored at the UE. In some embodiments, the NW providing the RSRP/RSRQ/SINR threshold may be omitted, such as when the threshold may be defined in a specification. The rest of the features of the second option may be the same as for the first option. For example, the UE may activate the SCell once the condition is met after UL traffic arrives at the buffer for transmission. The UE may indicate to the NW which SCells are activated. The UE may indicate the SCell activation and deactivation results to network once the UE completes one or more activation/deactivation of SCell(s). The RSRP/RSRQ/SINR threshold can be configured as a single threshold among different candidate CCs, different thresholds among different candidate CCs, different thresholds among different candidate bands, but same threshold for CCs inside a band, or different thresholds among different frequency range, but same threshold for CCs inside a FR.

There may be alternatives for the indication of activated SCells from the UE to the NW. For a first alternative, the indication may be provided via a PCell/PSCell or another activated SCell, e.g., valid CQI reporting or other new signaling indication. The valid CQI reporting may be associated with the cell index of the configured SCell, and after the NW receives valid CQI of this SCell, the NW can know this SCell has been activated by UE. In some instances of the first alternative, a list of cell index or carrier frequency may be provided by the UE as the indication. The list may be equal to or a sub-list of the candidate activation CC list. In some instances of the first alternative, the indication may include a bitmap of candidate activation list configured by the NW. For example, if initially the NW configures 8 candidate SCells to activate (cell 1/2/3/4/5/6/7/8), after the UE checks these candidates' RSRP/RSRQ/SINR measurement values with the threshold and after the UE completes the activation of cells 3/4, the UE may indicate 00110000 in the bitmap. That means cell 3/4 have been activated because bit position is “1” for these two cells. And for SCell deactivation, the UE may indicate 00010000, that means SCell 3 has been deactivated. The UE may release this SCell 3 but still keep cell 4 as an activated SCell in this case.

In a second alternative, the indication may include a random access channel (RACH) on the activated SCell. For example, the UE may generate a RACH transmission and transmit the RACH transmission on an activated SCell to indicate that the SCell has been activated. After the UE completes one SCell activation, the UE may send RACH on that SCell.

For the first alternative and/or the second alternative, the UE may send a scheduling request (SR) together with such above indication, and the NW can schedule UL grant for UL traffic on different CCs immediately.

For both option 1 and option 2, the RSRP/RSRQ/SINR threshold for SCell activation can be either NW configured or predefined in the specification. If UE can predict the DL traffic like the UL traffic in sixth generation (6G), the approach for UL SCell can also be applied for DL SCell activation.

The approach for conditional SCell activation may present some advantages. For example, the SCell activation may be more efficient than the current MAC CE based approach. The time delay from when the UE has UL traffic in buffer to when the UE can perform UL transmission on multiple activated SCCs may be shorter than legacy approaches.

The UE may let the NW know which SCell is activated and that needs some new design. The UE may have no load information for each CC, and therefore it is hard to balance the load from network perspective, e.g., the UE activated two CCs but these two CCs already have high UL load from other UEs. DL SCell activation may not be UE triggered.

The network can add some traffic or load information for different CCs. And UE can decide which one can be used for capacity enhancement. The load information can be associated with the CC index or Cell index, and the network may also configure a criteria to the UE, or the criteria can be predefined in the specification. For example, the activation of SCells can always start from the lowest load CC, if multiple CCs are above the conditional activation threshold. For example, in a first criteria option the UE may determine an amount of load on the CCs included in the list of configured SCells. The UE may select one or more of the CCs for activation, where the CCs with the lowest determined loads are selected by the UE first for activation. In a second criteria option, if multiple CCs activation are needed, the UE may choose the closest CCs for activation on frequency domain. For example, the UE may determine the frequencies of the CCs included in the list of configured SCells. The UE may prioritize selection of the CCs operating at the closest frequency levels to each other, operating within a same band, and/or operating within a same frequency range for activation.

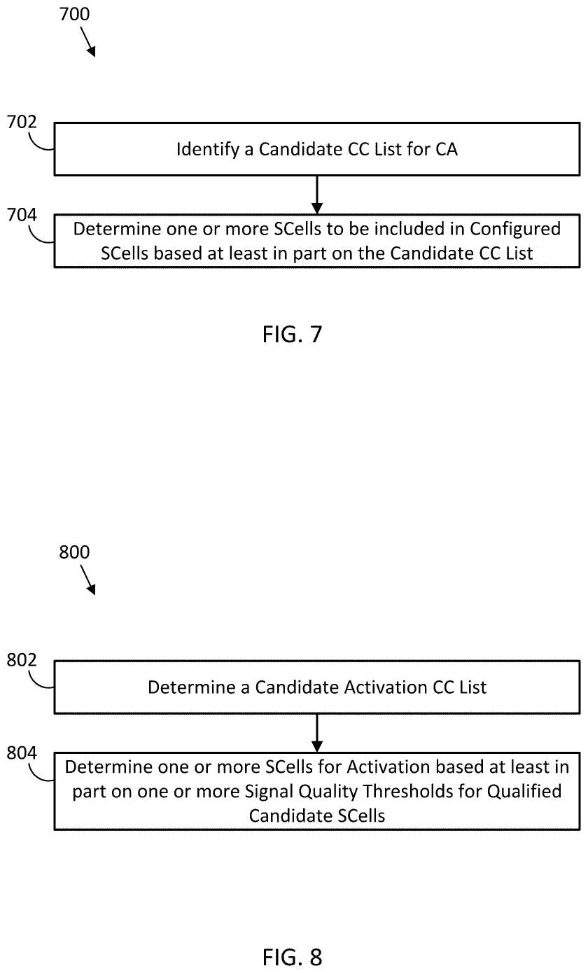

FIG. 7 illustrates an example procedure 700 for configuring SCells in accordance with some embodiments. For example, a UE may determine SCells to be configured and/or released. The procedure 700 may be performed by a UE, such as the UE 104 (FIG. 1), the UE 106 (FIG. 1), and/or the UE 200 (FIG. 2).

The procedure 700 may include identifying a candidate component carrier (CC) list for carrier aggregation (CA) in 702. For example, the UE may identify a candidate CC list received from a network, such as via a base station.

In some embodiments, the procedure 700 may further include identifying one or more thresholds for qualified candidate SCells. The one or more thresholds may include a single threshold for CCs within the candidate CC list, different thresholds for different CCs within the candidate CC list, different thresholds for different candidate bands for CCs within the candidate CC list, or different thresholds for different frequency ranges for CCs within the candidate CC list.

The procedure 700 may include determining one or more secondary cells (SCells) to be included in configured SCells based at least in part on the candidate CC list in 704. In some embodiments, determining the one or more SCells may include determining that SCells associated with CCs in the candidate CC list are to be included in the configured SCells. In some embodiments, determining the one or more SCells may include determining that SCells associated with CCs in the candidate CC list that meet the one or more thresholds are to be included in the configured SCells.

In some embodiments, the procedure 700 may further include generating an indication of the configured SCells for transmission. In some of these embodiments, the indication of the configured SCells may be generated responsive to at least one SCell being added to or released from the configured SCells, identifying a request to indicate the configured SCells, or identifying an event to trigger generation of the indication of the configured SCells.

In some embodiments, the procedure 700 may further include identifying activation of one or more secondary component carriers (SCCs). Further, the procedure 700 may include generating a report for transmission, wherein the report includes one or more channel quality indicators (CQIs) with one or more physical cell identity (PCI) indexes for the one or more SCCs.

In some embodiments, the procedure 700 may further include identifying load information for one or more CCs within the candidate activation CC list. The one or more SCells for activation may be determined based at least in part on the load information for the one or more CCs.

Any one or more of the operations in FIG. 7 may be performed in a different order than shown and/or one or more of the operations may be performed concurrently in embodiments. Further, it should be understood that one or more of the operations may be omitted from and/or one or more additional operations may be added to the procedure 700 in other embodiments.

FIG. 8 illustrates an example procedure 800 for activating SCells in accordance with some embodiments. For example, the UE may determine SCells to be activated or deactivated for operation. The procedure 800 may be performed by a UE, such as the UE 104 (FIG. 1), the UE 106 (FIG. 1), and/or the UE 200 (FIG. 2).

The procedure 800 may include determining a candidate activation component carrier (CC) list in 802. In some embodiments, determining the candidate activation CC list may include identifying the candidate activation CC list received from another apparatus.

The procedure 800 may include determining one or more secondary cells (SCells) for activation based at least in part on one or more signal quality thresholds for qualified candidate SCells in 804.

In some embodiments, the one or more signal quality thresholds may include a single threshold for CCs within the candidate CC list, different thresholds for different CCs within the candidate CC list, different thresholds for different candidate bands for CCs within the candidate CC list, or different thresholds for different frequency ranges for CCs within the candidate CC list. In some embodiments, the procedure 800 may further include identifying an indication of the one or more signal quality thresholds received from another apparatus.

In some embodiments, the procedure 800 may further include generating an indication of the one or more SCells for transmission. In some embodiments, generating the indication of the one or more SCells may include generating a channel quality indicator (CQI) reporting for the one or more SCells, generating a list of one or more cell indexes or one or more carrier frequencies for the one or more SCells, generating a bitmap indicating activated SCells, or generating one or more random access channel (RACH) transmissions for transmission on the one or more SCells.

Any one or more of the operations in FIG. 8 may be performed in a different order than shown and/or one or more of the operations may be performed concurrently in embodiments. Further, it should be understood that one or more of the operations may be omitted from and/or one or more additional operations may be added to the procedure 800 in other embodiments.

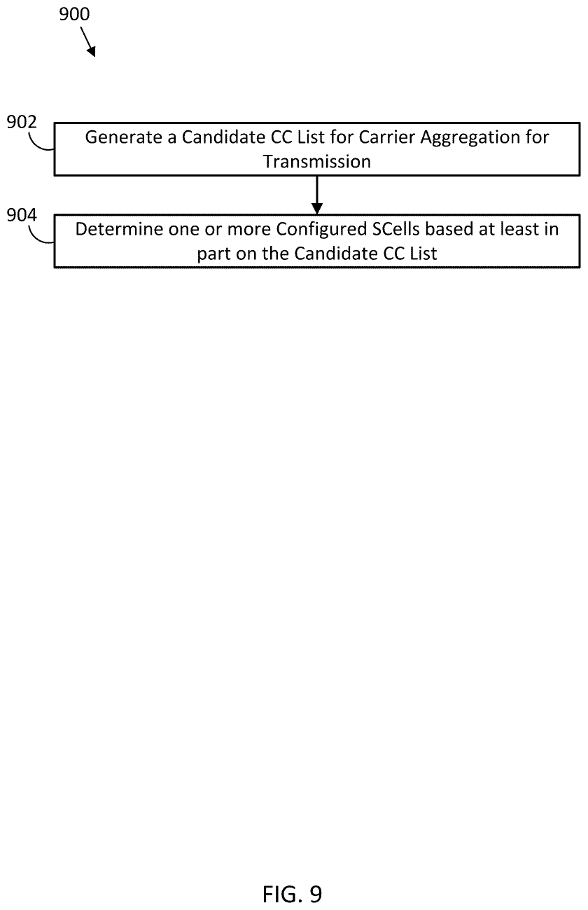

FIG. 9 illustrates an example procedure 900 for conditional addition and/or activation of SCells in accordance with some embodiments. For example, a network, via a base station, may provide information to a UE for configuration and/or activation of SCells. The procedure 900 may be performed by a base station, such as the base station 108 (FIG. 1) and/or the network device 300 (FIG. 3).

The procedure 900 may include generating a candidate component carrier (CC) list for carrier aggregation for transmission in 902.

The procedure 900 may include determining one or more configured secondary cells (SCells) based at least in part on the candidate CC list in 904. In some embodiments, determining the one or more configured SCells may include identifying an indication of an SCell list change, wherein the one or more configured SCells are determined based at least in part on the indication of the SCell list change, or identifying an indication of a configured SCell list, wherein the one or more configured SCells are determined based at least in part on the configured SCell list.

In some embodiments, the procedure 900 may include generating a request for a configured SCell list for transmission. Further, the procedure 900 may include identifying an indication of the configured SCell list, wherein the one or more configured SCells are determined based at least in part on the configured SCell list in these embodiments.

In some embodiments, the procedure 900 may include generating an indication of one or more thresholds for qualified candidate SCells to be configured.

In some embodiments, the procedure 900 may include generating a candidate activation CC list for transmission, the candidate activation CC list including one or more CCs from the one or more configured SCells. Further, the procedure 900 may include identifying an indication of one or more activated SCells in these embodiments. In some of these embodiments, identifying the indication of the one or more activated SCells includes identifying a channel quality indicator (CQI) reporting that indicates the one or more activated SCells, identifying a list of cell indexes or carrier frequencies that indicates the one or more activated SCells, identifying a bitmap that indicates the one or more activated SCells, or identifying a random access channel (RACH) transmission received on an SCell that has been activated.

In some embodiments, the procedure 900 may include generating an indication of one or more thresholds for qualified candidate SCells for activation.

Any one or more of the operations in FIG. 9 may be performed in a different order than shown and/or one or more of the operations may be performed concurrently in embodiments. Further, it should be understood that one or more of the operations may be omitted from and/or one or more additional operations may be added to the procedure 900 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method comprising identifying a candidate component carrier (CC) list for carrier aggregation (CA), and determining one or more secondary cells (SCells) to be included in configured SCells based at least in part on the candidate CC list.

Example 2 may include the method of example 1, wherein determining the one or more SCells includes determining that SCells associated with CCs in the candidate CC list are to be included in the configured SCells.

Example 3 may include the method of example 1, further comprising identifying one or more thresholds for qualified candidate SCells, wherein determining the one or more SCells includes determining that SCells associated with CCs in the candidate CC list that meet the one or more thresholds are to be included in the configured SCells.

Example 4 may include the method of example 3, wherein the one or more thresholds include a single threshold for CCs within the candidate CC list, different thresholds for different CCs within the candidate CC list, different thresholds for different candidate bands for CCs within the candidate CC list, or different thresholds for different frequency ranges for CCs within the candidate CC list.

Example 5 may include the method of example 1, further comprising generating an indication of the configured SCells for transmission.

Example 6 may include the method of example 5, wherein the indication of the configured SCells is generated responsive to at least one SCell being added to or released from the configured SCells, identifying a request to indicate the configured SCells, or identifying an event to trigger generation of the indication of the configured SCells.

Example 7 may include the method of example 1, further comprising identifying activation of one or more secondary component carriers (SCCs), and generating a report for transmission, wherein the report includes one or more channel quality indicators (CQIs) with one or more physical cell identity (PCI) indexes for the one or more SCCs.

Example 8 may include a method comprising determining a candidate activation component carrier (CC) list, and determining one or more secondary cells (SCells) for activation based at least in part on one or more signal quality thresholds for qualified candidate SCells.

Example 9 may include the method of example 8, wherein determining the candidate activation CC list includes identifying the candidate activation CC list received from another apparatus.

Example 10 may include the method of example 8, further comprising identifying an indication of the one or more signal quality thresholds received from another apparatus.

Example 11 may include the method of example 8, wherein the one or more signal quality thresholds include a single threshold for CCs within the candidate CC list, different thresholds for different CCs within the candidate CC list, different thresholds for different candidate bands for CCs within the candidate CC list, or different thresholds for different frequency ranges for CCs within the candidate CC list.

Example 12 may include the method of example 8, further comprising generating an indication of the one or more SCells for transmission.

Example 13 may include the method of example 12, wherein generating the indication of the one or more SCells includes generating a channel quality indicator (CQI) reporting for the one or more SCells, generating a list of one or more cell indexes or one or more carrier frequencies for the one or more SCells, generating a bitmap indicating activated SCells, or generating one or more random access channel (RACH) transmissions for transmission on the one or more SCells.

Example 14 may include the method of example 8, further comprising identifying load information for one or more CCs within the candidate activation CC list, wherein the one or more SCells for activation are determined based at least in part on the load information for the one or more CCs.

Example 15 may include a method comprising generating a candidate component carrier (CC) list for carrier aggregation for transmission, and determining one or more configured secondary cells (SCells) based at least in part on the candidate CC list.

Example 16 may include the method of example 15, wherein determining the one or more configured SCells includes identifying an indication of an SCell list change, wherein the one or more configured SCells are determined based at least in part on the indication of the SCell list change, or identifying an indication of a configured SCell list, wherein the one or more configured SCells are determined based at least in part on the configured SCell list.

Example 17 may include the method of example 15, further comprising generating a request for a configured SCell list for transmission, and identifying an indication of the configured SCell list, wherein the one or more configured SCells are determined based at least in part on the configured SCell list.

Example 18 may include the method of example 15, further comprising generating an indication of one or more thresholds for qualified candidate SCells to be configured.

Example 19 may include the method of example 15, further comprising generating a candidate activation CC list for transmission, the candidate activation CC list including one or more CCs from the one or more configured SCells, and identifying an indication of one or more activated SCells.

Example 20 may include the method of example 19, wherein identifying the indication of the one or more activated SCells includes identifying a channel quality indicator (CQI) reporting that indicates the one or more activated SCells, identifying a list of cell indexes or carrier frequencies that indicates the one or more activated SCells, identifying a bitmap that indicates the one or more activated SCells, or identifying a random access channel (RACH) transmission received on an SCell that has been activated.

Example 21 may include the method of example 19, further comprising generating an indication of one or more thresholds for qualified candidate SCells for activation.

Example 22 may include an apparatus comprising means to perform one or more elements of a method described in or related to any of examples 1-21, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 24 may include an apparatus comprising logic, modules, or circuitry to perform one or more elements of a method described in or related to any of examples 1-21, or any other method or process described herein.

Example 25 may include a method, technique, or process as described in or related to any of examples 1-21, or portions or parts thereof.

Example 26 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example 27 may include a signal as described in or related to any of examples 1-21, or portions or parts thereof.

Example 28 may include a datagram, information element, packet, frame, segment, PDU, or message as described in or related to any of examples 1-21, or portions or parts thereof, or otherwise described in the present disclosure.

Example 29 may include a signal encoded with data as described in or related to any of examples 1-21, or portions or parts thereof, or otherwise described in the present disclosure.

Example 30 may include a signal encoded with a datagram, IE, packet, frame, segment, PDU, or message as described in or related to any of examples 1-21, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example 32 may include a computer program comprising instructions, wherein execution of the program by a processing element is to cause the processing element to carry out the method, techniques, or process as described in or related to any of examples 1-21, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a candidate component carrier (CC) list for carrier aggregation (CA); and
determining one or more secondary cells (SCells) to be included in configured SCells based at least in part on the candidate CC list.

2. The method of claim 1, wherein determining the one or more SCells includes determining that SCells associated with CCs in the candidate CC list are to be included in the configured SCells.

3. The method of claim 1, further comprising:
identifying one or more thresholds for qualified candidate SCells, wherein determining the one or more SCells includes determining that SCells associated with CCs in the candidate CC list that meet the one or more thresholds are to be included in the configured SCells.

4. The method of claim 3, wherein the one or more thresholds include:
a single threshold for CCs within the candidate CC list;
different thresholds for different CCs within the candidate CC list;
different thresholds for different candidate bands for CCs within the candidate CC list; or
different thresholds for different frequency ranges for CCs within the candidate CC list.

5. The method of claim 1, further comprising:
generating an indication of the configured SCells for transmission.

6. The method of claim 5, wherein the indication of the configured SCells is generated responsive to:
at least one SCell being added to or released from the configured SCells;
identifying a request to indicate the configured SCells; or
identifying an event to trigger generation of the indication of the configured SCells.

7. The method of claim 1, further comprising:
identifying activation of one or more secondary component carriers (SCCs); and
generating a report for transmission, wherein the report includes one or more channel quality indicators (CQIs) with one or more physical cell identity (PCI) indexes for the one or more SCCs.

8. An apparatus comprising:
processing circuitry to:
determine a candidate activation component carrier (CC) list; and
determine one or more secondary cells (SCells) for activation based at least in part on one or more signal quality thresholds for qualified candidate SCells; and
interface circuitry coupled with the processing circuitry, the interface circuitry to enable communication.

9. The apparatus of claim 8, wherein to determine the candidate activation CC list includes to identify the candidate activation CC list received from another apparatus.

10. The apparatus of claim 8, wherein the processing circuitry is further to:
identify an indication of the one or more signal quality thresholds received from another apparatus.

11. The apparatus of claim 8, wherein the one or more signal quality thresholds include:
a single threshold for CCs within the candidate CC list;
different thresholds for different CCs within the candidate CC list;
different thresholds for different candidate bands for CCs within the candidate CC list; or
different thresholds for different frequency ranges for CCs within the candidate CC list.

12. The apparatus of claim 8, wherein the processing circuitry is further to:
generate an indication of the one or more SCells for transmission.

13. The apparatus of claim 12, wherein to generate the indication of the one or more SCells includes to:
generate a channel quality indicator (CQI) reporting for the one or more SCells;
generate a list of one or more cell indexes or one or more carrier frequencies for the one or more SCells;
generate a bitmap indicating activated SCells; or
generate one or more random access channel (RACH) transmissions for transmission on the one or more SCells.

14. The apparatus of claim 8, wherein the processing circuitry is further to:
identify load information for one or more CCs within the candidate activation CC list, wherein the one or more SCells for activation are determined based at least in part on the load information for the one or more CCs.

15. A method comprising:
generating a candidate component carrier (CC) list for carrier aggregation for transmission; and
determining one or more configured secondary cells (SCells) based at least in part on the candidate CC list.

16. The method of claim 15, wherein determining the one or more configured SCells includes:
identifying an indication of an SCell list change, wherein the one or more configured SCells are determined based at least in part on the indication of the SCell list change; or
identifying an indication of a configured SCell list, wherein the one or more configured SCells are determined based at least in part on the configured SCell list.

17. The method of claim 15, further comprising:
generating a request for a configured SCell list for transmission; and
identifying an indication of the configured SCell list, wherein the one or more configured SCells are determined based at least in part on the configured SCell list.

18. The method of claim 15, further comprising:
generating an indication of one or more thresholds for qualified candidate SCells to be configured.

19. The method of claim 15, further comprising:
generating a candidate activation CC list for transmission, the candidate activation CC list including one or more CCs from the one or more configured SCells; and
identifying an indication of one or more activated SCells.

20. The method of claim 19, wherein identifying the indication of the one or more activated SCells includes:
identifying a channel quality indicator (CQI) reporting that indicates the one or more activated SCells;
identifying a list of cell indexes or carrier frequencies that indicates the one or more activated SCells;
identifying a bitmap that indicates the one or more activated SCells; or
identifying a random access channel (RACH) transmission received on an SCell that has been activated.
